(19) United States
(12) Patent Application Publication
(10) Pub. No.: US 2006/0290455 A1
(43) Pub. Date: Dec. 28, 2006

(54) Radio frequency receiver chip with improved electrostatic discharge level

(75) Inventors: Tae Wook Kim, Austin, TX (US); Minsu Jeong, Gyeonggi-do (KR)

Correspondence Address: FOLEY AND LARDNER LLP;SUITE 500, 3000 K STREET NW, WASHINGTON, DC, 20007, US

(73) Assignee: Integrant Technologies Inc.

(21) Appl. No.: 11/471,642

(22) Filed: Jun. 21, 2006

(30) Foreign Application Priority Data
Jun. 22, 2005 (KR) 10-2005-0053877

(51) Int. Cl. H01F 21/06

(52) U.S. Cl. 336/130

(57) ABSTRACT

Provided is a radio frequency (RF) receiver chip improved with an electrostatic discharge (ESD) level. The RF receiver chip comprises an input terminal, a ground voltage terminal, and at least one bond-wire inductor. The bond-wire inductor couples the input terminal with the ground voltage terminal to reduce an electrostatic discharge (ESD) level and configure an input impedance matching circuit. Using the bond-wire inductor can improve the ESD level and minimize an increase of a noise figure. Also, the length of the bond-wire inductor can be adjusted through various coupling configurations to make ease of input matching.

The present invention claims the benefit of Korean Patent Application No. 10-2005-0053877 filed in Korea on Jun. 22, 2005, which is hereby incorporated by reference.

### BACKGROUND OF THE INVENTION

1. Field of the Invention

The present invention relates to a radio frequency (RF) receiver chip, and more particularly, to a RF receiver chip using a bond-wire inductor to improve an electrostatic discharge (ESD) level.

2. Description of the Background Art

An electrostatic discharge (ESD) event occurs when two different materials that have made contact to transfer charge separate from each other with different electrical potentials.

ESD that is usually generated in everyday life may give an unpleasant feeling to people, and can be very harmful to semiconductor integrated circuits.

Due to ESD generated in integrated circuits, an electrothermal migration (ETM) event often takes place, and this ETM event generally produces high voltage and high current, causing a short circuit or low impedance between terminals of transistors.

Particularly, metal-oxide semiconductor field effect transistors (MOSFET) need to have minimized ESD, which may damage dielectric materials.

One typical method to reduce ESD is to use a diode or zener diode that blocks ESD from flowing inside an integrated circuit by making ESD flow outside the integrated circuit.

However, this ESD blocking method often increases a noise figure (NF) because the diode or zener diode generally provides a capacitance loading effect due to a capacitance component thereof.

Downsizing the diode is necessary to reduce the NF; however, the downsizing of the diode lowers efficiency of reducing the ESD level. That is, the NF and the ESD level have a trade-off relationship. Therefore, using the large diode can improve the ESD level, but increases the NF. Thus, overall device functions may not be improved.

Also, an input terminal of a circuit, particularly, a circuit that processes RF signals need to maintain a certain level of input matching.

A typical RF receiver chip usually includes additional devices to maintain the input matching. As a result, an overall system circuit may get complicated and enlarged with increased costs.

### SUMMARY OF THE INVENTION

Accordingly, an aspect of the present invention is to solve at least the problems and disadvantages of the background art.

It is an aspect of the present invention to provide a RF receiver chip capable of removing ESD without using a diode that usually has limitations associated with a capacitance loading effect generated when removing ESD.

It is another aspect of the present invention to provide a RF receiver chip capable of simultaneously removing ESD and allowing easy input matching without using additional devices.

According to an embodiment of the present invention, a radio frequency (RF) receiver chip comprises an input terminal, a ground voltage terminal, and at least one bond-wire inductor coupling the input terminal with the ground voltage terminal to reduce an electrostatic discharge (ESD) level and configure an input impedance matching circuit.

In one embodiment, the input terminal may be an input terminal of a low noise amplifier.

In one embodiment, the bond-wire inductor may be coupled between the input terminal and the ground voltage terminal through a bonding point allocated outside the RF receiver chip and then another bonding point allocated inside the RF receiver chip.

In one embodiment of the present invention, the bond-wire inductor may be coupled between the input terminal and the ground voltage terminal through a bonding point allocated inside the RF receiver chip.

In one embodiment of the present invention, each of the bonding point allocated outside the RF receiver chip and the bonding point allocated inside the RF receiver chip may be configured to have at least two.

### BRIEF DESCRIPTION OF THE DRAWINGS

The invention will be described in detail with reference to the following drawings in which:

FIG. 1 illustrates a simplified RF receiver chip coupled with a bond-wire inductor according to an embodiment of the present invention;

FIG. 2 illustrates a simplified RF receiver chip coupled with a bond-wire inductor according to another embodiment of the present invention;

FIG. 3 illustrates a simplified RF receiver chip coupled with a bond-wire inductor according to another embodiment of the present invention;

FIG. 4 illustrates a simplified RF receiver chip coupled with a bond-wire inductor according to another embodiment of the present invention; and

FIG. 5 illustrates a simplified RF receiver chip coupled with a bond-wire inductor according to another embodiment of the present invention.

### DETAILED DESCRIPTION OF VARIOUS EMBODIMENTS

The above and other features and advantages of the present invention will become more apparent by describing in detail exemplary embodiments thereof with reference to attached drawings. The same reference numerals denote the same constituent elements in different drawings.

Generally, a bond-wire couples a chip with a package. Hereinafter, the two terms “bond-wire” and “bond-wire inductor” are used with distinction.

That is, the bond-wire is simply to couple a chip with a package, while the bond-wire inductor simultaneously couples a chip with a package and functions as an inductor provided by the bond-wire.

Also, the term “bonding point” refers to a point with which the bond-wire is coupled, and pads and leads in the following exemplary embodiments correspond to the bonding points.

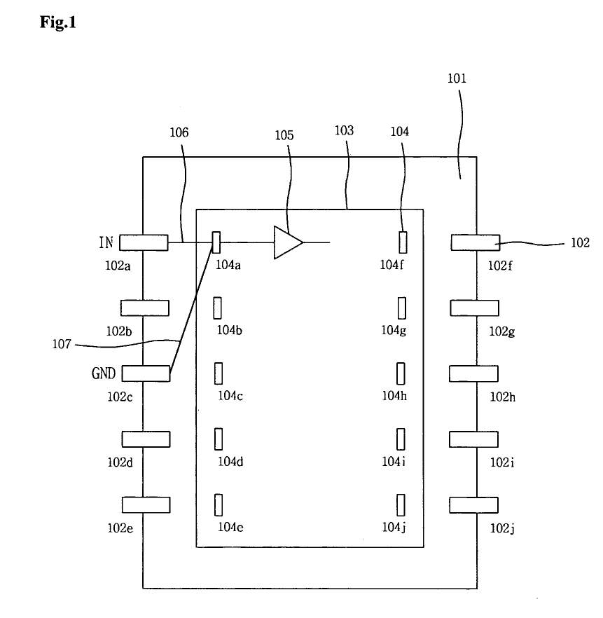

FIG. 1 illustrates a simplified RF receiver chip coupled with a bond-wire inductor according to an embodiment of the present invention.

The RF receiver chip 103 is packaged within a package 101, and a bond-wire can couple a pad 104 of the RF receiver chip 103 with a lead 102 of the package 101.

The RF receiver chip 103 comprises a certain number of input and output terminal pads but less than the total number of the pads. For instance, if n number of the input and output terminal pads of the RF receiver chip 103 is necessary to be coupled with an external circuit, the total number of the pads of the RF receiver chip is larger than n.

Assuming that the package 101 that packages the RF receiver chip 103 has m numbers of input and output terminal leads necessary for a coupling with an external circuit, the total number of the leads of the package 101 is larger than m.

Therefore, the RF receiver chip 103 and the package 101 comprise the larger number of the pads and leads than the number of the couplings between the input/output terminals and the external circuit. The redundant pads and leads are coupled with a bond-wire inductor to improve an ESD level.

Particularly in the present embodiment, a first pad 104a to a tenth pad 104j represent pads of the RF receiver chip 103, and a first lead 102a to a tenth lead 102j represent leads of the package 101.

That is, the total number of the pads and that of the leads are 10, but the number of the pads and that of the leads for input and output are 8. The second and third pads 104b and 104c and the second and third leads 102b and 102c are additional leads to lower the ESD level and set an input matching.

An initial signal processing terminal of the RF receiver chip 103 is a low noise amplifier (LNA) 105. An input terminal of the LNA 105 is coupled with the first pad 104a. The bond-wire 106 couples the first pad 104a with the first lead 102a, which is coupled with an input terminal IN.

Another bond-wire 107 couples the first pad 104a with the third lead 102c, and the third lead 102c is coupled with a ground voltage terminal GND.

The other bond-wire 107 that couples the first pad 104a with the third lead 102c serves as a bond-wire inductor. Thus, the bond-wire 107 is referred to as “bond-wire inductor” hereinafter.

The bond-wire inductor 107 removes ESD and thus, an increase of NF can be reduced as compared with the typical diode.

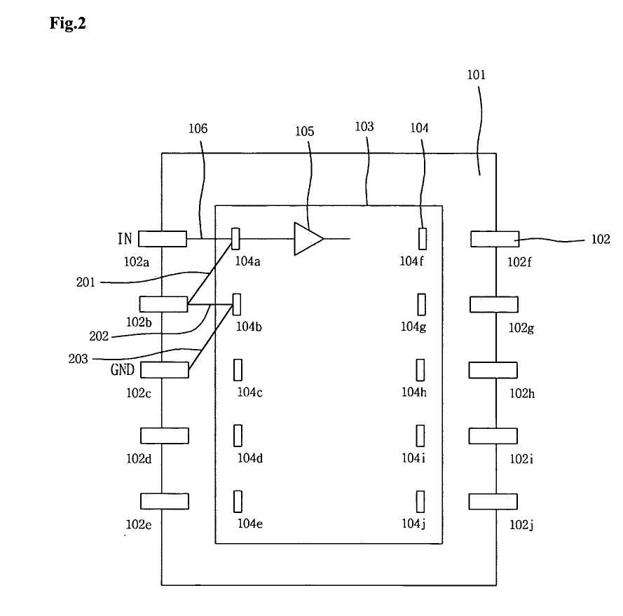

FIGS. 2 through 5 illustrate other exemplary couplings of the bond-wire inductor 107 modified from the above embodied coupling illustrated in FIG. 1.

As illustrated in FIG. 2, a signal processing terminal of a RF receiver chip 103 is an LNA 105. An input terminal of the LNA 105 is coupled with a first pad 104a. The bond-wire 106 couples the first pad 104a with the first lead 102a, which is coupled with an input terminal IN.

Another bond-wire 201 couples the first pad 104a with a second lead 102b, which is coupled with a second pad 104b through another bond-wire 202. A further another bond-wire 203 couples the second pad 104b with a third lead 102c, which is also coupled with a ground voltage terminal GND.

In general, a bond-wire inductor of a RF receiver additionally serves as an inductor. Adjusting the length of the bond-wire inductor is effective to set input matching.

The length of the bond-wire inductor 107 illustrated in FIG. 1 can be adjusted by configuring a bypass connection as illustrated in FIG. 2.

In FIG. 2, the bond-wire inductor 201 is coupled with the second lead 102b of the package 101 at the input terminal of the RF receiver chip 103, and another bond-wire inductor 202 is coupled between the second lead 102b and the second pad 104b of the RF receiver chip 103 and then, the second pad 104b is coupled with the third lead 102c of the package 101 via another bond-wire inductor 203. Through this bond-wire configuration, the lengths of the bond-wire inductors 201, 202 and 203 can be adjusted.

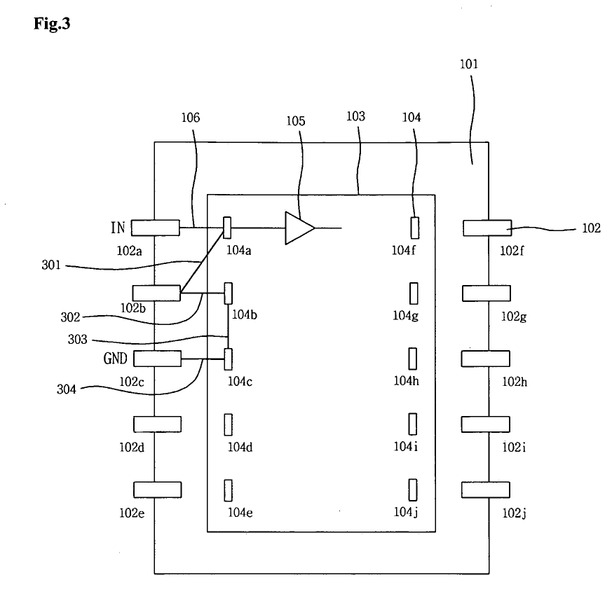

FIG. 3 illustrates a simplified RF receiver chip coupled with a bond-wire inductor according to another embodiment of the present invention.

A signal processing terminal of the RF receiver chip 103 is an LNA 105. An input terminal of the LNA 105 is coupled with a first pad 104a, which is coupled with a first lead 102a via a bond wire 106.

Another bond-wire 301 couples the first pad 104a with a second lead 102b, which is coupled with a second pad 104b via another bond-wire 302. The second pad 104b is then coupled with a third pad 104c via another bond-wire 303.

The third pad 104c is coupled with a third lead 102c via another bond-wire 304, and the third lead 102c is also coupled with a ground voltage terminal GND. This coupling configuration allows adjustment of the lengths of the bond-wire inductors 301 302, 303 and 304.

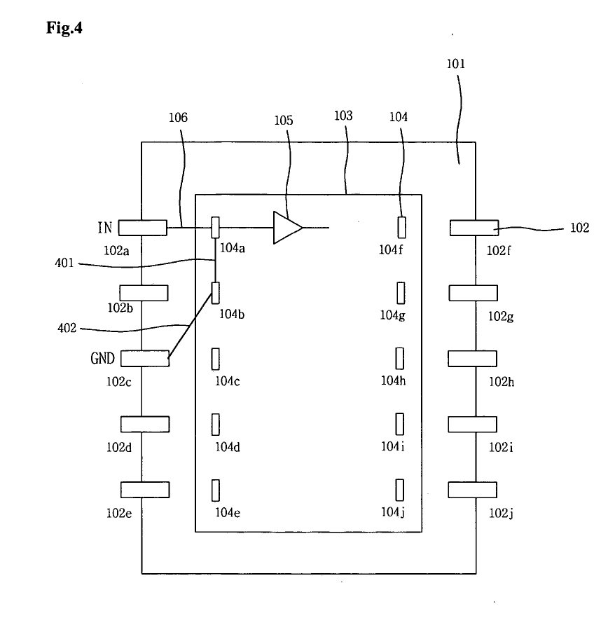

FIG. 4 illustrates a RF receiver chip coupled with a bond-wire inductor according to another embodiment of the present invention.

An initial signal processing terminal of the RF receiver chip 103 is an LNA 105. An input terminal of the LNA 105 is coupled with a first pad 104a, which is coupled with a first lead 102a through a bond-wire 106.

Another bond-wire 401 couples the first pad 104a with a second pad 104b, and the second pad 104b is coupled with a third lead 102c through another bond-wire 402. The third lead 102c is also coupled with a ground voltage terminal GND. Through this coupling configuration, the lengths of the bond-wire inductors 401 and 402 can be adjusted.

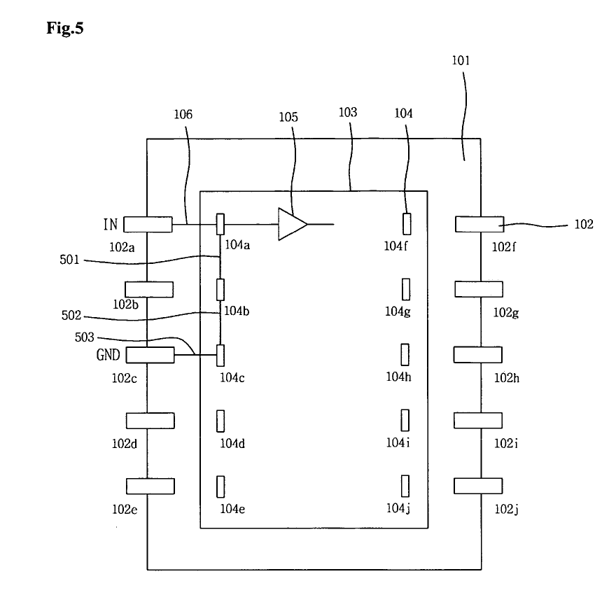

FIG. 5 illustrates a RF receiver chip coupled with a bond-wire inductor according to another embodiment of the present invention.

An initial signal processing terminal of the RF receiver chip 103 is an LNA 105.

An input terminal of the LNA 105 is coupled with a first pad 104a, which is coupled with a second pad 104b via a bond-wire 501.

Another bond-wire 502 couples the second pad 104b with a third pad 104c. The third pad 104c is coupled with a third lead 102c via another bond-wire 503. The third lead 102c is also coupled with a ground voltage terminal GND. Using this bond-wire coupling configuration, the lengths of the bond-wire inductors 501, 502 and 503 can be adjusted.

Although FIGS. 1 to 5 illustrate the specific embodiments in adjusting the lengths of the bond-wire inductors through making bond-wire couplings between the pads of the RF receiver chip and the leads of the package, it will be apparent for those skilled in the art that a method of controlling inductance for input matching is not limited to these specific embodiments.

Particularly, the lengths of the bond-wire inductors can be adjusted by changing bonding paths between the pads and the leads depending on needs. Hence, it is obvious that the scope and sprit of the present invention are not limited to the above exemplified embodiments.

The bond-wire inductors configured according to the various embodiments of the present invention can effectively remove ESD usually generated at the input terminal of the RF receiver chip.

An inductance value can be adjusted by adjusting the lengths of the bond-wire inductors at the input terminal. Thus, the RF receiver chip can easily set input matching.

The embodiment of the invention being thus described, it will be obvious that the same may be varied in many ways without modifying the technical spirit and scope of the invention.

Such variations are not to be regarded as a departure from the spirit and scope of the invention, and all such modifications as would be obvious to one skilled in the art are intended to be included within the scope of the following claims.

What is claimed is:

1. A radio frequency receiver chip, comprising:
an input terminal;
a ground voltage terminal; and
at least one bond-wire inductor coupling the input terminal with the ground voltage terminal to reduce an electrostatic discharge level and configure an input impedance matching circuit.

2. The RF receiver chip of claim 1, wherein the input terminal is an input terminal of a low noise amplifier.

3. The RF receiver chip of claim 1, wherein the bond-wire inductor is coupled between the input terminal and the ground voltage terminal through a bonding point allocated outside the RF receiver chip and then another bonding point allocated inside the RF receiver chip.

4. The RF receiver chip of claim 1, wherein the bond-wire inductor is coupled between the input terminal and the ground voltage terminal through a bonding point allocated inside the RF receiver chip.

5. The RF receiver chip of claim 3, wherein each of the bonding point allocated outside the RF receiver chip and the bonding point allocated inside the RF receiver chip is configured to have at least two.

6. The RF receiver chip of claim 4, wherein each of the bonding point allocated outside the RF receiver chip and the bonding point allocated inside the RF receiver chip is configured to have at least two.
